(19) United States
(12) Patent Application Publication
(10) Pub. No.: US 2026/0084482 A1
(43) Pub. Date: Mar. 26, 2026

(54) AUTOMOTIVE ANTI-ROLL BAR DAMPER

(71) Applicant: HARBIN RUIGUANG HAIHUI TECHNOLOGY DEVELOPMENT CO., LTD., Harbin City (CN)

(72) Inventor: Lichao YUAN, Harbin City (CN)

(21) Appl. No.: 19/408,324

(22) Filed: Dec. 3, 2025

Related U.S. Application Data
(63) Continuation of application No. PCT/CN2024/096967, filed on Jun. 3, 2024.

(30) Foreign Application Priority Data
Jun. 12, 2023 (CN) 202321474867.1
Mar. 15, 2024 (CN) 202420509918.8

(51) Int. Cl. B60G 21/055

(52) U.S. Cl. CPC B60G 21/0553

(57) ABSTRACT

A novel automobile anti-roll bar damper includes a spring fastening rod, a damping spring, a damping adjustment rod, angle adjusters, and fastening hoops at two ends, wherein the spring fastening rod is composed of an outer cylinder and an inner rod, and the fastening hoops at the two ends include a left end fastening hoop and a right end fastening hoop, respectively connected to a left end angle adjuster and a right end angle adjuster, the left end angle adjuster is connected to the outer cylinder of the spring fastening rod by using a turnbuckle, the right end angle adjuster is connected to an inner rod of the damping adjustment rod by using a turnbuckle. According to the anti-roll bar damper, the rollover of an automobile body during cornering of the automobile can be effectively reduced and the quality of straight-line driving can be improved.

### CROSS-REFERENCE

This application is a continuation of International Application No. PCT/CN2024/096967 with a filling date of Jun. 3, 2024, designating the United states, now pending, and further claims to the benefit of priority from Chinese Application No. 202321474867.1 with a filing date of Jun. 12, 2023. The content of the aforementioned applications, including any intervening amendments thereto, are incorporated herein by reference.

### TECHNICAL FIELD

The present disclosure relates to the technical field of automotive chassis, in particular to a novel automotive ant-roll bar damper that effectively reduces vehicle body roll during cornering and improves straight-line driving quality.

### BACKGROUND

The chassis anti-roll bar is an important component of the vehicle suspension system, also known as the stabilizer bar, which has a significant impact on the handling of the vehicle. The two ends of the anti-roll bar are connected to the suspension arm. When the vehicle body rolls, the anti-roll bar will twist in the same direction and generate feedback force in the opposite direction to control the tilt of the vehicle body. Therefore, the anti-roll bar is actually a twisting spring. When a vehicle turns, the centrifugal force causes the body to roll, causing the suspension of the inner wheel to stretch and the suspension of the outer wheel to compress, causing the anti-roll bar to twist. The function of the anti-roll bar is to use the rebound force generated by the twisting of the bar to suppress the body roll.

The existing automotive suspension design generally connects the anti-roll bar to the anti-roll bar link, and then connects the anti-roll bar link to the shock absorber or chassis control arm, thereby generating a connection force to suppress the angle change of the anti-roll bar. The anti-roll bar and anti-roll bar link are generally connected by ball joints, which not only allows the vehicle to have a certain degree of roll, but also facilitates the vehicle's movement in non straight lines. However, using ball joints for connection also has side effects because the ball joints are relatively fragile, and the limit strength of new parts is not high. After a period of use, they are more prone to loosening, resulting in insufficient connection strength between the anti-roll bar link and the anti-roll bar, and the roll reduction effect of anti-roll bar becomes weaker. So increasing the connection strength of the anti-roll bar, enhancing the stability of of the anti-roll bar, reducing the angle changes and vibrations of the anti-roll bar during vehicle operation, reducing cornering and tilting, and improving the quality of straight-line driving are the problems needed to solve.

### SUMMARY

In view of the deficiencies and gaps in existing technologies, the present disclosure provides a novel automotive anti-roll bar damper and its connection method. This damper is capable of dynamically adjusting damping through extension and retraction, while static damping can be regulated via a damping adjustment rod. One end of the damper is connected to the chassis anti-roll bar, while the other end of the damper is linked to the anti-roll bar link or to the lower straight arm, lower control arm, or nearby fixed points. By enhancing the connection damping between the anti-roll bar and the anti-roll bar link or lower swing arm, the changes in the angle and vibration of the anti-roll bar are reduced during vehicle movement. Overall, it improves the stability of the motion of the anti-roll bar, effectively minimizing body roll during cornering while simultaneously enhancing ride comfort during straight-line driving.

In addition, while solving the above problems, it is also necessary to consider the weight and volume of the technical solution structure, because the anti-roll bar and anti-roll bar link are both located in the chassis of the vehicle. Excessive increase in chassis weight will inevitably affect the performance of the vehicle during driving or high-speed driving. Meanwhile, many vehicles have complex chassis and limited available space, so the volume control of technical solution is crucial.

In order to achieve the above objectives, the following technical solutions are adopted.

### Technical Solution

### The First Technical Solution

A novel automotive anti-roll bar damper, including a spring fastening rod, a damping spring, a damping adjustment rod, angle adjusters, and fastening hoops at two ends. The spring fastening rod is composed of an outer cylinder and an inner rod. The fastening hoops at two ends include a left end fastening hoop and a right end fastening hoop, which are respectively connected to the left end angle adjuster and the right end angle adjuster. The left end angle adjuster is connected to the outer cylinder of the spring fastening rod with a turnbuckle, and the right end angle adjuster is connected to the damping adjusting inner rod with a turnbuckle. The spring fastening rod and the damping spring are composite telescopic structures, connected by spring fixing hooks. The outer rod of the damping adjustment rod is connected to the inner rod of the spring fastening rod with a turnbuckle.

Preferably, the spring fastening rod is a low damping rod with a static initial length between 2 mm and 600 mm and a fully extended length between 4 mm and 1200 mm. The spring fastening rod is divided into an outer cylinder and an inner rod, with the outer cylinder fixed in place and the inner rod sealed with a sealing ring inside the outer cylinder. The spring fastening rod fixes and limit the spring.

Preferably, the damping spring has a length between 2 mm and 500 mm, a wire diameter ranging from 0.1 mm to 10 mm, and an inner diameter ranging from 3 mm to 50 mm. It increases damping when stretched and returns to its initial position together with the inner rod of the spring fastening rod when retracted.

Preferably, the damping adjustment rod includes an inner rod and an outer rod. The lengths of the inner rod and the outer rod that completely overlap is between 0 mm and 300 mm, and the lengths of the inner rod and the outer rod that completely extend is between 0 mm and 600 mm.

Preferably, the angle adjuster includes a left end angle adjuster and a right end angle adjuster, connected to a fastening hoop and a damping adjustment rod or a spring fastening rod, and capable of multi angle adjustment, specifically a universal joint, a ball head or a connecting ring.

Preferably, the fastening hoops at two ends include a left end fastening hoop and a right end fastening hoop, which are annular or U-shaped fastening hoops. One end of the anti-roll bar damper is fixed to the anti-roll bar of the vehicle, and the other end of the anti-roll bar damper is fixed to the anti-roll bar link, or to the suspension straight arm or fixed point near the anti-roll bar. The inner diameter of the fastening hoop is circular with a radius ranging from 2 mm to 80 mm, or rectangular with a length ranging from 2 mm to 150 mm and a width ranging from 5 mm to 150 mm.

Preferably, the damping spring and the spring fastening rod are a parallel composite structure, combined with a damping adjustment rod, one end of the parallel composite structure is connected to the anti-roll bar of the vehicle, and the other end of the parallel composite structure is connected to the anti-roll bar link or suspended lower straight arm or lower control arm.

Preferably, in the anti-roll bar damper, when the length of the inner rod of the spring fastening rod in the parallel composite structure of the spring and the spring fastening rod is relatively small, the inner rod of the spring fastening rod is pulled out, and the inner rod is unidirectionally clamped and limited by a sealing ring of the outer rod, and the entire damper becomes a hard connection.

Preferably, the angle formed between the anti-roll bar damper and the anti-roll bar when the anti-roll bar damper is connected to the anti-roll bar and the anti-roll bar link is adjusted between 0 degrees and 90 degrees, and the angle formed between the anti-roll bar damper and the anti-roll bar when the anti-roll bar damper is connected to the anti-roll bar and the lower straight arm is adjusted between 0 degrees and 90 degrees.

Preferably, another assembly structure for the damping spring and the spring fastening rod is that the spring fastening rod is on the outside and the damping spring is inside the spring fixing cylinder.

### Effect of the Above Technical Solution

The above technical solution solves the problem of insufficient strength in the connection between the anti-roll bar and the suspension, dynamically strengthening the damping of the connection between the anti-roll bar and the anti-roll bar link or lower swing arm, and overall increasing the stability of the anti-roll bar during movement. The composite structure of spring fastening rod and the damping spring strengthens the connection strength between the anti-roll bar and the suspension. When the vehicle body rolls, the composite structure of one side of the spring becomes longer and the damping increases, achieving the effect of reducing the angle of the anti-roll bar. When the vehicle body returns to its original position due to the elastic properties of the composite structure. The function of the spring fastening rod is also to fix the spring in the lateral direction, reducing the excess vibration of the spring in the lateral direction during vehicle movement, and making the vehicle suspension run linearly and stably. The spring fastening rod requires the damping to be set as low as possible, because the damping must accompany the extension and retraction of the damping spring, which follows the same rhythm as the change in the center of gravity of the vehicle.

The damping adjustment rod itself is a hard connection. With the fastening hoops at both ends fixed, the length of the overall spring structure can be adjusted by adjusting the length of the damping adjustment rod to set the initial damping. If the total length of the damping adjustment rod is shorter, the initial damping of the overall spring structure will increase, and if the total length of the damping adjustment rod is longer, the initial damping of the overall spring structure will decrease. When the vehicle body rolls, the overall structure of the spring on one side becomes longer and the damping increases, achieving the goal of reducing the angle of the anti-roll bar. If an anti-roll bar damper is installed in a very small space, adjusting the angle of the fastening hoop alone will adjust the initial damping of the spring and the length of the damper.

The function of the angle adjuster is to connect the spring composite structure, damping adjustment rod, and the fastening hoop at the widest angle, as well as their contact points with the vehicle suspension. This ensures that there is no excess running resistance from the above components during various driving movements of the vehicle, and maximizes the damping effect.

At the same time, in the driving scenarios, the extension and retraction of the spring fastening rod can be set to a very small range, which does not affect the steering of the vehicle, and can also be limited by the one-way blocking of the outer cylinder sealing ring of the spring fastening rod as long as there is a small amount of stretching of the inner rod of the spring fastening rod during vehicle driving. At this time, not only the damping force generated by the spring but also the damping force generated by the hard limit of the inner rod of the spring fastening rod will be achieved. In this state, the entire damper will be rigidly connected to the anti-roll bar and chassis suspension, effectively preventing vehicle rolling.

The angle variation of the vehicle anti-roll bar, including the roll angle of the anti-roll bar when the vehicle rolls and the vibration amplitude variation of the anti-roll bar when the vehicle moves in a straight line. The anti-roll bar damper can effectively reduce the roll angle of the anti-roll bar and the vibration amplitude of the anti-roll bar during vehicle straight-line motion, improving the quality of straight-line driving. Under the initial damping setting of the anti-roll bar damper, when the angle between the anti-roll bar damper and the anti-roll bar during connection is greater than 45 degrees, the effect of the damper tends to reduce the change in vibration amplitude of the anti-roll bar; when the angle is less than 45 degrees, the effect of the damper tends to reduce the roll angle of the anti-roll bar. According to the data of the experimental vehicle, when the angle is set to 60 degrees, the straight-line driving quality and the reduction of vehicle rolling reach a balance point between comfort and motion.

### The Second Technical Solution

A novel automotive anti-roll bar damper, including a spring fastening rod, a damping spring, a left end fastening hoop, and a right end fastening hoop, wherein the left end fastening hoop is connected to the outer cylinder connecting hole of the spring fastening rod with bolts, and the right end fastening hoop is connected to the inner rod connecting hole of the spring fastening rod with bolts. The left end spring fixing hook of the damping spring is fastened in the left end spring hook fixing slot, and the right end spring fixing hook is fastened in the right end spring hook fixing slot. The spring fastening rod includes an outer cylinder and an inner rod, and is a composite telescopic structure with the damping spring, connected by a spring fixing hook.

Preferably, the spring fastening rod is a low damping rod, divided into an outer cylinder and an inner rod. The initial length of the spring fastening rod is between 2 millimeters and 600 millimeters, and the fully stretched length of the spring fastening rod is between 5 millimeters and 1200 millimeters. The outer cylinder is fixed and the inner rod is sealed with a sealing ring inside the outer cylinder. The spring fastening rod fixes and limits the spring.

Preferably, the damping spring includes three settings: a double-end necked spring, a center-necked spring, and a single-sided necked spring. The damping spring has a wire diameter between 0.1 mm and 20 mm, an inner diameter between 2 mm and 100 mm, and a length between 2 mm and 500 mm. The damping spring is sleeved outside the spring fixing rod and has a composite telescopic structure with the spring fixing rod. It increases damping when stretched and returns to its initial position together with the inner rod of the spring fixing rod when retracted.

Preferably, the left and right end fastening hoops are annular or U-shaped fastening hoops. The annular fastening hoop has a radius ranging from 2 millimeters to 80 millimeters, and the U-shaped fastening hoop has a length ranging from 2 millimeters to 150 millimeters and a width ranging from 5 millimeters to 200 millimeters. One end of the anti-roll bar damper is fixed to the anti-roll bar of the vehicle, and the other end of the anti-roll bar damper is fixed to the anti-roll bar link, or to the suspension straight arm or fixed point near the anti-roll bar. The inner diameter of the fastening hoops is circular or rectangular.

Preferably, one end of the damping spring is connected to the anti-roll bar of the vehicle, and the other end of the damping spring is connected to the anti-roll bar link or the suspension lower straight arm or lower control arm or fixed point.

Preferably, in the anti-roll bar damper, when the length of the inner rod of the spring fastening rod in the parallel composite structure of the spring and the spring fastening rod is relatively small, the inner rod of the spring fastening rod is pulled out, and the inner rod is unidirectionally clamped and limited by the outer rod sealing ring, and the entire damper becomes a hard connection.

Preferably, another assembly structure for the damping spring and the spring fastening rod is that the spring fastening rod is on the outside and the damping spring is inside the spring fixing cylinder. One end of the damping spring is fixed to the closed end inside the outer cylinder of the spring fastening rod, and the other end of the damping spring is fixed to the inner rod of the spring fastening rod and is inserted into the outer cylinder end, sealed and fixed with a sealing ring.

Preferably, the gap between the inner wall of the outer cylinder and the outer wall of the inner rod is between 0 millimeters and 10 millimeters.

In addition, the proportion of the length of the middle spring coil part of the double-end necked spring to the total length of the spring shall not be less than 80%, the proportion of the length of the middle spring coil part of the center-necked spring to the total length of the spring shall not be more than 80% (including 80%) or less than 40% (including 40%), and the proportion of the length of the single side spring coil part of the single-sided necked spring to the total length of the spring shall not be more than 40%.

The above technical solution solves the problem of insufficient strength in the connection between the anti-roll bar and the suspension, dynamically strengthening the damping of the connection between the anti-roll bar and the anti-roll bar link or lower swing arm, and overall increasing the stability of the anti-roll bar during movement. The composite structure of spring fixing rod and the damping spring strengthens the connection strength between the anti-roll bar and the suspension. When the vehicle body rolls, the composite structure of one side of the spring becomes longer and the damping increases, achieving the effect of reducing the angle of the anti-roll bar. When the vehicle body returns to its original position due to the elastic properties of the composite structure. The function of the spring fixing rod is also to fix the spring in the lateral direction, reducing the excess vibration of the spring in the lateral direction during vehicle movement, and making the vehicle suspension run linearly and stably. The spring fastening rod requires the damping to be set as low as possible, because the damping must accompany the extension and retraction of the damping spring, which follows the same rhythm as the change in the center of gravity of the vehicle.

The design of directly connecting the left and right fastening hoops to the spring fixing rod simplifies the steps and reduces the weight of the entire regulator, minimizing the impact of weight on the chassis during regulator movement.

Using the double-end necked spring, the center-necked spring, and the single-sided necked spring, different spring wire necks a and c are designed with different ratios to the coil to increase the proportion of the straight part a and c of spring as much as possible, reduce the proportion of the coil, and increase the wire diameter of the coil. This can ensure the damping of the spring, reduce the weight of the spring, and increase the rigidity of the spring in the straight direction, achieving the goal of reducing the vibration of the spring caused by vehicle movement and making the vehicle running more linearly and comfortably.

In the driving scenarios, the extension and retraction of the spring fastening rod can be set to a very small range, which does not affect the steering of the vehicle, and can also be limited by the one-way blocking of the outer cylinder sealing ring of the spring fastening rod as long as there is a small amount of stretching of the inner rod of the spring fastening rod during vehicle driving. At this time, not only the damping force generated by the spring but also the damping force generated by the hard limit of the inner rod of the spring fastening rod will be achieved. In this state, the entire damper will be rigidly connected to the anti-roll bar and chassis suspension, effectively preventing vehicle rolling.

The angle variation of the vehicle anti-roll bar, including the roll angle of the anti-roll bar when the vehicle rolls and the vibration amplitude variation of the anti-roll bar when the vehicle moves in a straight line. The anti-roll bar damper can effectively reduce the roll angle of the anti-roll bar and the vibration amplitude of the anti-roll bar during vehicle straight-line motion, improving the quality of straight-line driving. Under the initial damping setting of the anti-roll bar damper, when the angle between the anti-roll bar damper and the anti-roll bar during connection is greater than 45 degrees, the effect of the damper tends to reduce the change in vibration amplitude of the anti-roll bar; when the angle is less than 45 degrees, the effect of the damper tends to reduce the roll angle of the anti-roll bar. According to the data of the experimental vehicle, when the angle is set to 60 degrees, the straight-line driving quality and the reduction of vehicle rolling reach a balance point between comfort and motion.

Although both of the above technical solutions have solved the problem of the connection force between the anti-roll bar and the anti-roll bar link of the vehicle, the degree of solution is different, the functions achieved are not completely the same, and the effects achieved are also not completely the same.

In the first technical solution, angle adjusters and a damping adjustment rod are added. The angle adjuster is usually a universal joint. In the limited space where the anti-roll bar and anti-roll bar link are connected in mass-produced vehicles, the angle adjuster can always connect the entire damper to the anti-roll bar and the anti-roll bar link at a suitable angle. The function of the damping adjustment rod is to adjust the length of the damping adjustment rod to meet the required damping after the installation and testing of the entire damper.

In the second technical solution, by connecting the anti-roll bar and the anti-roll bar link through a damping spring and a spring fastening rod, the connection force is increased. At the same time, the angle adjuster and one end of the spring fastening rod are integrated together, reducing weight and volume, in this way, the damping adjustment rod is removed, and the initial damping of the spring can be adjusted by fine-tuning the position of the fastening hoop. This reduces the volume, makes it easier to install the damper in a small space, and reduces the weight of the damper, minimizing its impact on the vehicle chassis. So choose the first technical solution from the perspective of optimal effect, and choose the second technical solution for installation in a narrow space.

### BRIEF DESCRIPTION OF THE DRAWINGS

Because there are two technical solutions depending on the degree of solution, the first digit of the second technical solution is 6, and the first digit of the first technical solution is 7.

The illustration of the first solution with accompanying drawings:

FIG. 1 is a structural diagram of a novel automotive anti-roll bar damper in the uninstalled condition;

FIG. 2 is a structural diagram of the novel automotive anti-roll bar damper in micro tension state when the vehicle is stationary after installation;

FIG. 3 is a structural diagram of a fastening hoop and an angle connector.

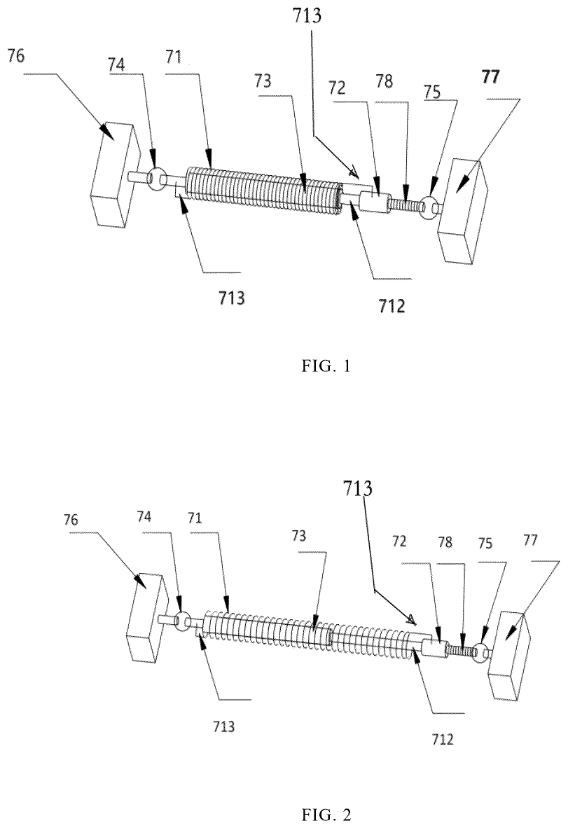

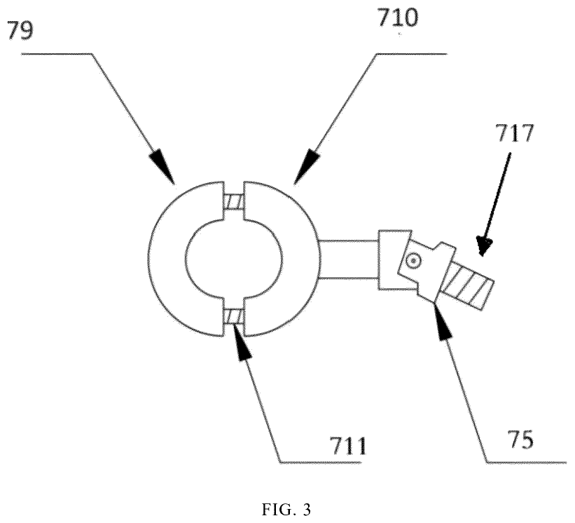

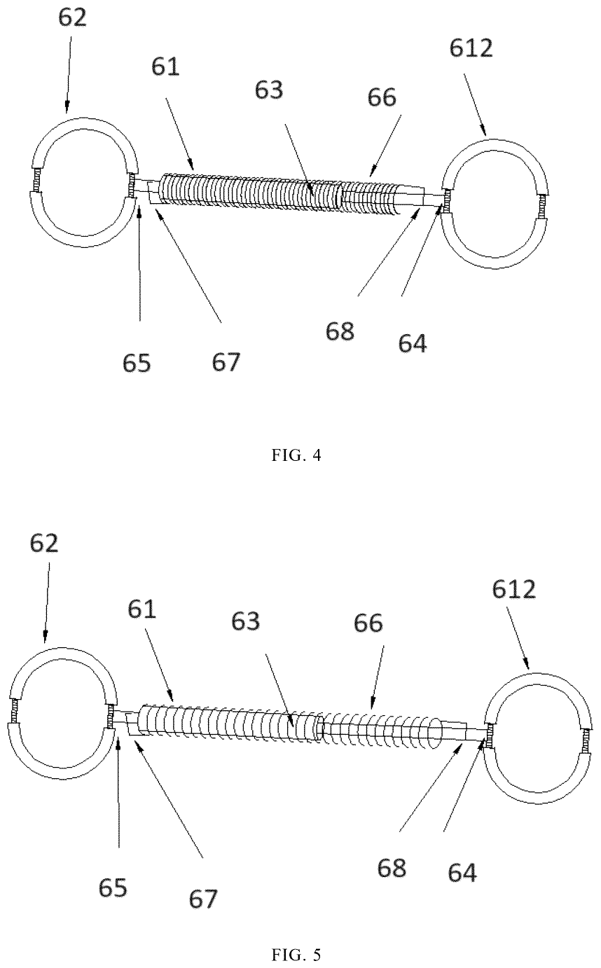

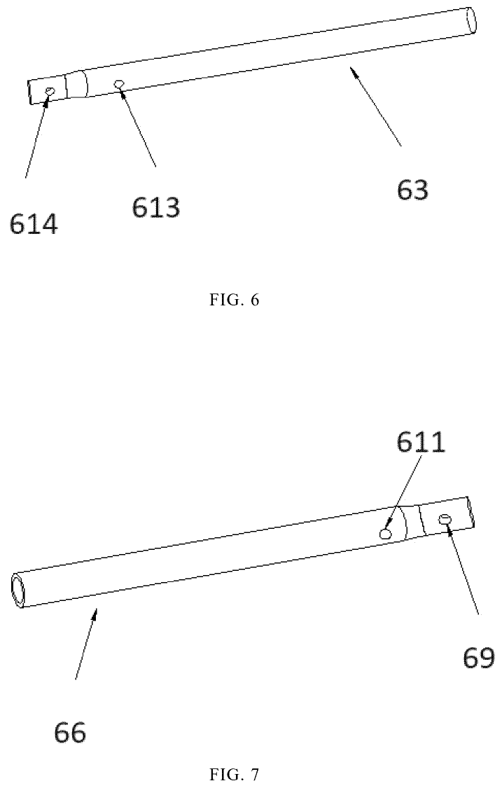

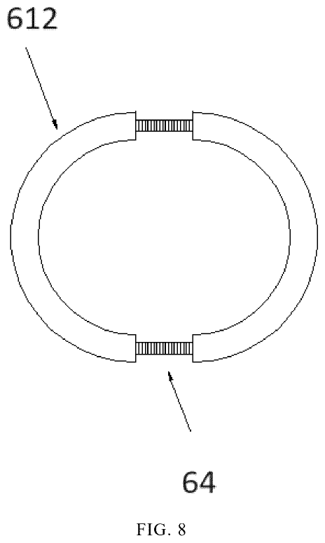

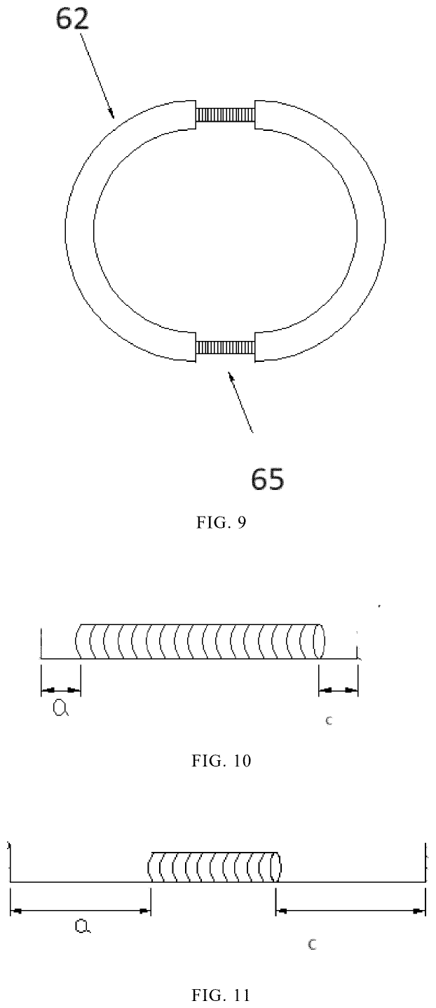

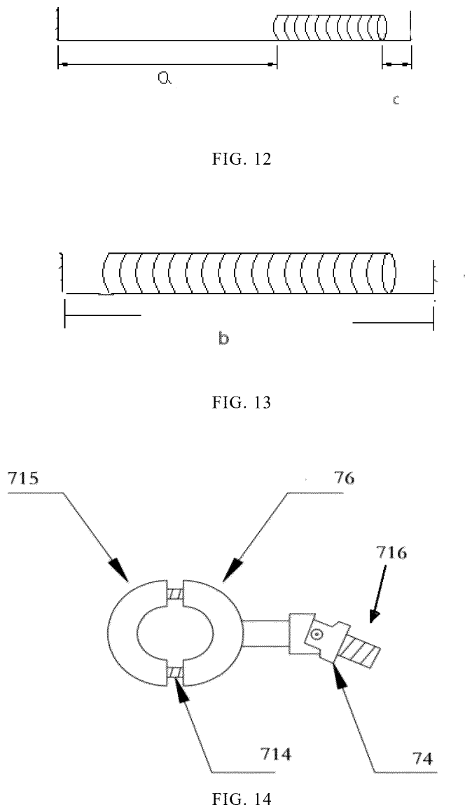

The reference numbers labeled various parts in the diagrams: 71 damping spring, 72 damping adjustment outer rod, 73 outer cylinder of spring fastening rod,
74 left end angle adjuster, 75 right end angle adjuster, 76 left end fastening hoop, 77 right end fastening hoop,
78 damping adjustment inner rod, 79 separated fastening hoop, 711 fixing ring screw, 712 inner rod of spring fastening rod, 713 spring fixing hook, 714 fixed fastening hoop screw,
715 separated fastening hoop, 716 left end angle adjuster turnbuckle, right end angle adjuster turnbuckle.

The illustration of the second solution with accompanying drawings:

FIG. 4 is a structural diagram of a novel automotive anti-roll bar damper in an uninstalled condition;

FIG. 5 a structural diagram of the novel automotive anti-roll bar damper in micro tension state when the vehicle is stationary after installation;

FIG. 6 is a schematic diagram of a spring fixing outer cylinder;

FIG. 7 is a schematic diagram of a spring fixing inner rod;

FIG. 8 is a schematic diagram of a left end fastening hoop;

FIG. 9 is a schematic diagram of a right end fastening hoop;

FIG. 10 is a schematic diagram of a double-end necked spring;

FIG. 11 is a schematic diagram of a center-necked spring;

FIG. 12 is a schematic diagram of a single-sided necked spring;

FIG. 13 shows the total length b of the spring, which is the distance from the left endpoint to the right endpoint of the spring;

FIG. 14 is a structural diagram of a left end fastening hoop and an angle connector.

The reference numbers labeled various parts: 61 damping spring, 62 left end fastening hoop, 63 outer cylinder of spring fastening rod, 64 right end fastening hoop bolt, 65 left end fastening hoop bolt, 66 inner rod of spring fastening rod, 67 left end spring fixing hook, 68 right end spring fixing hook, 69 inner rod connecting hole of the spring fastening rod, 611 right end spring hook fixing slot, 612 right end fastening hoop, 613 left end spring hook fixing slot, 614 outer cylinder connecting hole of the spring fastening rod, a is the distance between the spring coil and the spring fixing hook.

The names of the left end fastening hoop, the right end fastening hoop, the double-end necked spring, the center-necked spring, and the single-sided necked spring are only for illustration purposes and are not professional terms or have any other meanings.

The total length b of the spring is the length of the spring from the left end endpoint to the right end endpoint, as shown in FIG. 13.

Common spring materials include vehiclebon spring steel, alloy spring steel, and non-ferrous alloy.

### DETAILED DESCRIPTION OF THE EMBODIMENTS

The following is an illustration of the implementation of this solutions. In addition, in various figures, the size ratios of the figures are sometimes enlarged for illustration purposes. The material of the fastening hoop is a common metal in this field, which is different from the actual ratio.

### The Embodiment of the First Technical Solution

1. A novel automotive anti-roll bar damper includes a spring fastening rod, a damping spring, a damping adjustment rod, angle adjusters, and fastening hoops at two ends. The spring fastening rod is composed of an outer cylinder and an inner rod. The fastening hoops at two ends include a left end fastening hoop and a right end fastening hoop, which are respectively connected to the left end angle adjuster and the right end angle adjuster. The left end angle adjuster is connected to the outer cylinder of the spring fastening rod with a turnbuckle, and the right end angle adjuster is connected to an inner rod of the damping adjustment rod with a turnbuckle. The spring fastening rod and the damping spring are a composite telescopic structure, connected by spring fixing hooks. An outer rod of the damping adjustment rod is connected to an inner rod of the spring fastening rod with a turnbuckle.
2. The length of the outer cylinder of the spring fastening rod is 72 millimeters, excluding the screw rods at both ends, with an inner diameter of 15 millimeters. The length of the inner rod of the spring fastening rod in the middle is 40 millimeters, with an outer diameter of 6 millimeters. The wire diameter of the spring is 1.5 millimeters and the length of the spring is 60 millimeters, excluding the spring fixing hooks at both ends. The length of the spring fixing hook is 15 millimeters, the entire inner diameter of the spring is 18 millimeters, and the material is spring steel. The outer rod length of the damping adjustment rod is 45 millimeters, the outer hexagonal diameter is 8 millimeters, the inner rod length is 40 millimeters, the diameter is 6 millimeters, and the material is stainless steel. The angle adjuster is set as a universal joint, with an inner diameter of 6 millimeters at the end connected to the damping adjustment rod and 8 millimeters at the end connected to the spring fastening rod, another end is connected to the separated fastening hoop with a turnbuckle and made of stainless steel. The separated fastening hoop at one end of the damper has an inner diameter of 22 millimeters, an outer diameter of 45 millimeters, a thickness of 20 millimeters, and is made of aluminum. The separated fastening hoop on the other end of the damper has an inner diameter of 10 millimeters, an outer diameter of 30 millimeters, a thickness of 20 millimeters, and is made of aluminum. The 22 millimeter port of this damper fastening hoop is fitted onto the anti-roll bar of the vehicle, the 10 millimeter port of the fastening hoop is fitted onto the anti-roll bar link, the distance is 10 millimeters that the damping rod inner rod of the composite spring structure is pulled out, and the damping adjustment rod inner rod is exposed at a position of 10 millimeters.
3. In a novel automotive anti-roll bar damper, an outer cylinder length of the spring fixing rod is 85 millimeters, excluding screw rods at both ends, an inner diameter of the spring fixing rod is 18 millimeters, and an inner rod length of the spring fixing rod in the middle is 60 millimeters and an outer diameter is 6 millimeters. The wire diameter of the spring is 1.2 millimeters and the length is 70 millimeters, excluding the spring fixing hooks at both ends. The inner diameter of the entire spring is 22 millimeters, and the material is 304 stainless steel. The outer rod length of the damping adjustment rod is 65 millimeters, the outer hexagonal diameter is 10 millimeters, the inner rod length is 50 millimeters, the diameter is 6 millimeters, and the material is galvanized steel. The angle adjuster is set as a universal joint, with an inner diameter of 6 millimeters at the end connected to the damping adjustment rod and the spring fixing rod, and the other end connected to the separated fastening hoop with a turnbuckle, made of stainless steel. The separated fastening hoop at one end of the damper has an inner diameter of 35 millimeters, an outer diameter of 60 millimeters, a thickness of 25 millimeters, and is made of aluminum. The other end of the separated fastening hoop of the the damper is a U-shaped clamp, with an inner width of 23 millimeters, a length of 80 millimeters, and a thickness of 15 millimeters, customized according to the specific lower straight arm profile of the vehicle model. The 35 mm port of this damper fastening hoop is installed on the anti-roll bar of the vehicle, and the U-shaped clamp port of the separated fastening hoop is installed on the lower straight arm of the vehicle. The set distance is 15 mm when the inner rod of the damping rod with a composite spring structure is pulled out, and the inner rod of the damping adjustment rod is exposed 15 mm.
4. In a novel automotive anti-roll bar damper, an outer cylinder length of the spring fixing rod is 85 millimeters, excluding screw rods at both ends, an inner diameter of the spring fixing rod is 18 millimeters, and an inner rod length of the spring fixing rod in the middle is 60 millimeters and an outer diameter of 6 millimeters. The wire diameter of the spring is 1.2 millimeters and the length is 70 millimeters, excluding the spring fixing hooks at both ends. The inner diameter of the entire spring is 22 millimeters, and the material is 304 stainless steel. The length of the damping adjustment rod is 0. The angle adjuster is set as a universal joint, an inner diameter of two ends of the universal joint connected to the spring fixing rod is 6 millimeters, and the other two ends of the universal joint connected to the separated fastening hoop with a turnbuckle, made of stainless steel. The separated fastening hoop at one end of the damper has an inner diameter of 35 millimeters, an outer diameter of 60 millimeters, a thickness of 25 millimeters, and is made of aluminum. The separated fastening hoop at the other end of the damper has an inner diameter of 10 millimeters and a thickness of 15 millimeters. This damper fastening hoop is fitted with a 35 mm port on the car anti-roll bar, and the detachable fixing clamp is fitted with a 10 mm port on the vehicle anti-roll bar link.
5. In a novel automotive anti-roll bar damper, an outer cylinder length of the spring fixing rod is 65 millimeters, excluding screw rods at both ends, an inner diameter is 12 millimeters, and an inner rod length of the spring fixing rod in the middle is 40 millimeters, and an outer diameter is 6 millimeters. The wire diameter of the spring is 2.2 millimeters, the length is 70 millimeters, including the spring fixing hooks at both ends. The inner diameter of the entire spring is 16 millimeters, and the material is 304 stainless steel. The length of the damping adjustment rod is 0. The angle adjuster is set as a universal joint, and an inner diameter of two ends of the universal joint connected to the spring fixing rod is 4 millimeters, and the other two ends of the universal joint is connected to the separated fixing clamps with a turnbuckle, which is made of stainless steel. The separated fastening hoop at one end of the damper has an inner diameter of 23 millimeters, an outer diameter of 40 millimeters, a thickness of 15 millimeters, and is made of aluminum alloy. The separated fastening hoop at the other end of the damper has an inner diameter of 9 millimeters and a thickness of 15 millimeters. This damper fastening hoop is fitted with a 23 mm port on the vehicle anti-roll bar and a 9 mm port on the vehicle anti-roll bar link.
6. Automotive moose test to verify the effect of anti-roll bar dampers. Taking the BMW 325 model as an example, when the anti-roll bar damper is not installed, the first test is conducted at a speed of 80 kilometers per hour. The front of the vehicle is unstable, the body rolls severely, and the left side of the front of the vehicle scratched a traffic cone. Then, the rear of the vehicle slides noticeably, and when exiting a turn, the rear of the vehicle also flips over a traffic cone. Then, the cornering speed is reduced to 75 kilometers per hour. Although the front of the vehicle rolls more severely than the rear of the vehicle, and the vehicle may sway when exiting a turn, it still meets the cornering standard. Still taking the same BMW 325 model for testing, in this time, the BMW 325 model is equipped with anti-roll bar dampers on both sides of the suspension, as described in the first technical solution mentioned above. The spring wire diameter is 1 millimeter, the inner diameter is 18 millimeters, and the spring length is 60 millimeters. It passes through at a speed of 75 kilometers per hour to meet the cornering standard, and the overall body rolling is not very severe. When the speed is increased to 80 kilometers per hour, the body rolls to a certain extent, but meets the cornering standard, moreover, the front of the vehicle does not show significant sway. And the speed is increased to 83 kilometers per hour, it still meet the cornering standard, however, the body rolls severely and the front of the vehicle swings, indicating that under the setting of the anti-roll bar damper installed in this vehicle, the strengthening of the chassis has reached its limit state. After a before-and-after comparison, it can be shown that the anti-roll bar damper provided by the above technical solution significantly suppresses the angular variation of the vehicle anti-roll bar, thereby significantly reducing vehicle body roll.
7. Anti-roll bar dampers manufactured according to the above embodiment are respectively installed on the experimental vehicles. One installation method has an angle of 62 degrees between the damper and the anti-roll bar, and the second installation method has an angle of 35 degrees between the damper and the anti-roll bar. Compared with before installation, the first installation method significantly improves the straight driving quality and anti-roll ability, while the second installation method does not significantly improve the straight driving quality but significantly reduces cornering roll. Therefore, it is more suitable to set the angle to be greater than 45 degrees for general roads.

The embodiment of the second technical solution
8. A novel automotive anti-roll bar damper, including a spring fastening rod, a damping spring, a left end fastening hoop, and a right end fastening hoop. The left end fastening hoop is connected to the outer cylinder connecting hole of the spring fastening rod through bolts, while the right end fastening hoop is connected to the inner rod connecting hole of the spring fastening rod through bolts. The left end spring fixing hook of the damping spring is buckled in the left end spring hook fixing slot, and the right end spring fixing hook is buckled in the right end spring hook fixing slot. The spring fastening rod includes an outer cylinder and an inner rod, forming a composite telescopic structure with the damping spring, connected by spring fixing hooks. The wire diameter of metal spring is between 0.1 mm and 10 mm, the inner diameter is between 2 mm and 30 mm, and the length is between 2 mm and 500 mm. The initial length of the spring fastening rod is between 2 mm and 600 mm, and the fully extended length is between 5 mm to 1200 mm. The radius of annular the fastening hoop is between 2 mm and 80 mm, the length of the U-shaped fastening hoop is between 2 mm and 150 mm, and the width is between 5 mm and 200 mm. In addition, the proportion of the length of the middle spring coil part of the double-end necked spring to the total length of the spring shall not be less than 80%, the proportion of the length of the middle spring coil part of the center-necked spring to the total length of the spring shall not be more than 80% (including 80%) or less than 40% (including 40%), and the proportion of the length of the single side spring coil part of the single-sided necked spring to the total length of the spring shall not be more than 40%.
9. The outer cylinder of the spring fastening rod has a length of 72 mm and an inner diameter of 15 mm. The inner rod of spring fastening rod in the middle has a length of 40 mm and an outer diameter of 6 mm, made of aluminum alloy, and is fixed to the outer cylinder with a sealing ring. The wire diameter of the double-end necked spring is 1.5 mm, the lengths of both sides a and c of the spring straight neck are 18 mm, the total length of the spring is 100 mm, the inner diameter of the entire spring is 18 mm, and the material is spring steel. The damping spring is fixed in the fixing slots at both ends of the outer cylinder and inner rod of the spring fastening rod. The inner diameter of the left end fastening hoop is 22 mm, the outer diameter is 45 mm, the thickness is 20 mm, and the material is aluminum alloy. The inner diameter of the right end fastening hoop is 10 mm, the outer diameter is 30 mm, the thickness is 20 mm, and the material is stainless steel. The fastening hoop of the damper with 22 mm port is sleeved on the car anti-roll bar, and the fastening hoop of the damper with 10 mm port is sleeved on the anti-roll bar link.
10. The outer cylinder of the spring fastening rod has a length of 300 mm and an inner diameter of 30 mm. The inner rod of spring fastening rod in the middle has a length of 200 mm and an outer diameter of 15 mm, made of stainless steel, and is fixed to the outer cylinder with a sealing ring. The wire diameter of the double-end necked spring is 5 mm, the total length of the spring is 400 mm, the lengths of a and c of the spring straight neck are 30 mm, the inner diameter of the entire spring is 40 mm, and the material is manganese steel. The damping spring is fixed in the fixing slots at both ends of the outer cylinder and inner rod of the spring fastening rod. The inner diameter of the left end fastening hoop is 80 mm, the thickness is 20 mm, and the material is aluminum alloy. The inner diameter of the right end fastening hoop is 30 mm, and the material is stainless steel. The fastening hoop of the damper with 80 mm port is sleeved on the modified car anti-roll bar, and the fastening hoop of the damper with 30 mm port is sleeved on the modified anti-roll bar link.
11. The outer cylinder of the spring fastening rod has a length of 45 mm and an inner diameter of 10 mm. The inner rod of spring fastening rod in the middle has a length of 35 mm and an outer diameter of 6 mm, made of carbon fiber, and is fixed to the outer cylinder with a sealing ring. The wire diameter of the double-end necked spring is 0.5 mm, the total length of the spring is 41 mm, the lengths of both sides a and c of the spring straight neck are 8 mm, the inner diameter of the entire spring is 40 mm, and the material is spring steel. The damping spring is fixed in the fixing slots at both ends of the outer cylinder and inner rod of the spring fastening rod. The inner diameter of the left end fastening hoop is 23 mm, the thickness is 20 mm, and the material is aluminum alloy. The inner diameter of the right end fastening hoop is 9 mm, and the material is stainless steel. The fastening hoop of the damper with 23 mm port is sleeved on the modified car anti-roll bar, and the fastening hoop of the damper with 9 mm port is sleeved on the anti-roll bar link.
12. The damping spring and the spring fastening rod have another assembly structure, with the spring fastening rod on the outside and the damping spring inside the spring fixing cylinder. The outer cylinder is connected to the left end fastening hoop, and the inner rod is connected to the right end fastening hoop. The outer cylinder and the inner rod are made of aluminum alloy material. One end of the damping spring is fixed to an closed end inside the outer cylinder of the spring fastening rod, and the other end of the damping spring is fixed to the inner rod of the spring fastening rod and is inserted into the outer cylinder end. When in static state, the inner rod is pulled out of the outer cylinder at a one-third position, the inner diameter of the outer cylinder is 30 mm, the length is 150 mm, the outer diameter of the inner rod is 8 mm, and the length is 80 mm, and the inner rod is sealed and fixed with a sealing ring. The wire diameter of the center-necked spring is 0.6 mm, the diameter is 20 mm, and the length is 80 mm and the material is spring steel. The left end fastening hoop has an inner diameter of 23 mm and is fixed on the car anti-roll bar. The right end U-shaped fastening hoop is 15 mm long and 8 mm wide and is fixed on the lower straight arm or bent arm.
13. In damper, when the length of the inner rod of the spring fastening rod in the parallel composite structure of the spring and the spring fastening rod is relatively small, the inner rod of the spring fastening rod is pulled out, the inner rod of the spring fastening rod is unidirectionally clamped and limited by the outer rod sealing ring, and the entire damper becomes a hard connection. The outer cylinder of the spring fastening rod has a length of 102 mm and an inner diameter of 15 mm. The inner rod of spring fastening rod in the middle has a length of 40 mm and an outer diameter of 6 mm, made of aluminum alloy, and is fixed to the outer cylinder with a sealing ring. The wire diameter of the single-sided necked spring is 2.5 mm, the total length of the spring is 120 mm, the lengths of a and c of the spring straight neck are 85 mm, the inner diameter of the entire spring is 18 mm, and the material is spring steel. The spring coil is fixed on one side of the outer cylinder of the spring fastening rod. The damping spring is fixed in the fixing slots at both ends of the outer cylinder and inner rod of the spring fastening rod. The inner diameter of the left end fastening hoop is 15 mm, the outer diameter is 45 mm, the thickness is 20 mm, and the material is aluminum alloy. The inner diameter of the right end fastening hoop is 10 mm, the outer diameter is 30 mm, the thickness is 20 mm, and the material is stainless steel. The fastening hoop of the damper with 15 mm port is sleeved on the car anti-roll bar, and the fastening hoop of the damper with 10 mm port is sleeved on the anti-roll bar link.
14. The outer cylinder of the spring fastening rod has a length of 100 mm and an inner diameter of 16 mm. The inner rod of spring fastening rod in the middle has a length of 60 mm and an outer diameter of 8 mm, made of aluminum alloy, and is fixed to the outer cylinder with a sealing ring. The wire diameter of the center-necked spring is 1.5 mm, the lengths of a and c of the spring straight neck are 50 mm, the total length of the spring is 90 mm, the inner diameter of the entire spring is 18 mm, and the material is spring steel. The damping spring is fixed in the fixing slots at both ends of the outer cylinder and inner rod of the spring fastening rod. The inner diameter of the left end fastening hoop is 22 mm, the outer diameter 45 mm, the thickness is 20 mm, and the material is aluminum alloy. The inner diameter of the right end fastening hoop is 10 mm, the outer diameter 30 mm, the thickness is 20 mm, and the material is stainless steel. The fastening hoop of the damper with 22 mm port is sleeved on the car anti-roll bar, and the fastening hoop of the damper with 10 mm port is sleeved on the anti-roll bar link.
15. The outer cylinder of the spring fastening rod has a length of 105 mm and an inner diameter of 16 mm. The inner rod of spring fastening rod in the middle has a length of 60 mm and an outer diameter of 8 mm, made of aluminum alloy, and is fixed to the outer cylinder with a sealing ring. The wire diameter of the single-sided necked spring is 1.6 mm, the lengths of a and c of the spring straight neck are 60 mm, the total length of the spring is 70 mm, the inner diameter of the entire spring is 19 mm, and the material is spring steel. The part of the single-sided necked spring with coil should be sleeved on one side of the outer cylinder of the spring fastening rod. The damping spring is fixed in the fixing slots at both ends of the outer cylinder and inner rod of the spring fastening rod. The inner diameter of the left end fastening hoop is 22 mm, the outer diameter is 45 mm, the thickness is 20 mm, and the material is aluminum alloy. The inner diameter of the right end fastening hoop is 10 mm, the outer diameter is 30 mm, the thickness is 20 mm, and the material is stainless steel. The fastening hoop of the damper with 22 mm port is sleeved on the modified car anti-roll bar, and the fastening hoop of the damper with 10 mm port is sleeved on the anti-roll bar link.
16. Automotive moose test to verify the effect of the chassis adjuster. Taking the BMW 325 model as an example, when the anti-roll bar damper is not installed, the first test is conducted at a speed of 80 kilometers per hour. The front of the vehicle is unstable, the body rolls severely, and the left side of the front of the vehicle scratched a traffic cone. Then, the rear of the vehicle slides noticeably, and when exiting a turn, the rear of the vehicle also flips over a traffic cone. Then, the cornering speed is reduced to 75 kilometers per hour. Although the front of the vehicle rolls more severely than the rear of the vehicle, and the vehicle may sway when exiting a turn, it still meets the cornering standard. Still taking the same BMW 325 model for testing, in this time, the BMW 325 model is equipped with anti-roll bar dampers on both sides of the suspension, as described in the first technical solution mentioned above. The spring wire diameter is 1.5 millimeter, the inner diameter is 18 millimeters, and the spring length is 60 millimeters. It passes through at a speed of 75 kilometers per hour to meet the cornering standard, and the overall body rolling is not very severe. When the speed is increased to 80 kilometers per hour, the body rolls to a certain extent, but meets the cornering standard, moreover, the front of the vehicle does not show significant sway. And the speed is increased to 83 kilometers per hour, it still meet the cornering standard, however, the body rolls severely and the front of the vehicle swings, indicating that under the setting of the anti-roll bar damper installed in this vehicle, the strengthening of the chassis has reached its limit state. After a before-and-after comparison, it can be shown that the anti-roll bar damper provided by the above technical solution significantly suppresses the angular variation of the vehicle anti-roll bar, thereby significantly reducing vehicle body roll.

The technique provided by the present disclosure uses a composite structure of damping springs and spring fastening rods in parallel. By directly connecting the vehicle anti-roll bar to the anti-roll bar link or lower straight arm, the angle and vibration changes of the anti-roll bar can be effectively reduced, thereby achieving the goal of reducing the body roll of moving vehicles and improving the quality of straight-line driving.

The above embodiments do not impose any form of limitation on the shape, material, structure, etc. of this technical solution, and the specific data provided are only the preferred technical solution. Any simple modifications, equivalent substitutions, and modifications made to the above embodiments based on the technical essence of this technical solution are within the scope of this technical solution.

What is claimed is:

1. A novel automotive anti-roll bar damper, comprising a spring fastening rod, a damping spring, a damping adjustment rod, angle adjusters, and fastening hoops at two ends, wherein the spring fastening rod is composed of an outer cylinder and an inner rod, the fastening hoops at two ends include a left end fastening hoop and a right end fastening hoop, and the left end fastening hoop and the right end fastening hoop are respectively connected to a left end angle adjuster and a right end angle adjuster; the left end angle adjuster is connected to the outer cylinder of the spring fastening rod with a turnbuckle, and the right end angle adjuster is connected to an inner rod of the damping adjustment rod with a turnbuckle; the spring fastening rod and the damping spring are a composite telescopic structure, connected by spring fixing hooks, and an outer rod of the damping adjustment rod is connected to an inner rod of the spring fastening rod with a turnbuckle.

2. A novel automotive anti-roll bar damper, comprising a spring fastening rod, a damping spring, a left end fastening hoop, and a right end fastening hoop, wherein the left end fastening hoop is connected to an outer cylinder connecting hole of the spring fastening rod with bolts, and the right end fastening hoop is connected to an inner rod connecting hole of the spring fastening rod with bolts; a left end spring fixing hook of the damping spring is fastened in a left end spring hook fixing slot, and a right end spring fixing hook is fastened in a right end spring hook fixing slot; the spring fastening rod comprises an outer cylinder and an inner rod, and the spring fastening rod combined with the damping spring is a composite telescopic structure, connected by spring fixing hooks.

3. The novel automotive anti-roll bar damper according to claim 1, characterized in that the spring fastening rod is a low damping rod, with a static initial length between 2 mm and 600 mm and a fully stretched length between 4 mm and 1200 mm, the spring fastening rod is divided into an outer cylinder and an inner rod, with the outer cylinder fixed in place and the inner rod inside the outer cylinder, sealed with a sealing ring, and the spring fastening rod fixes and limits the spring.

4. The novel automotive anti-roll bar damper according to claim 1, characterized in that the damping spring has a length between 2 mm and 500 mm, a wire diameter ranging from 0.1 mm to 10 mm, and an inner diameter ranging from 3 mm to 50 mm; when stretched, a damping of the damping spring is increased, and when contracted, the damping spring returns to an initial position together with the inner rod of the spring fastening rod.

5. The novel automotive anti-roll bar damper according to claim 1, characterized in that the damping adjustment rod comprises an inner rod and an outer rod, and the length of the inner rod and the outer rod that completely overlap is between 0 mm and 300 mm, and the length of the inner rod and the outer rod that fully stretched is between 0 mm and 600 mm.

6. The novel automotive anti-roll bar damper according to claim 1, characterized in that the angle adjuster comprises a left end angle adjuster and a right end angle adjuster, the angle adjuster is connected to a fastening hoop and a damping adjustment rod or a spring fastening rod, and is capable of achieving multi-angle adjustment, specifically a universal joint, a ball joint or a connecting ring.

7. The novel automobile anti-roll bar damper according to claim 1, characterized in that the fastening hoops at two ends include a left end fastening hoop and a right end fastening hoop, which are annular or U-shaped fastening hoops; one end of the anti-roll bar damper is fixed to the anti-roll bar of the automobile, and the other end of the anti-roll bar damper is fixed to the anti-roll bar link, or fixed to the suspension straight arm or fixed point near the anti-roll bar; the inner diameter of the fastening hoop is circular with a radius ranging from 2 mm to 80 mm, or rectangular with a length ranging from 2 mm to 150 mm and a width ranging from 5 mm to 150 mm.

8. The novel automotive anti-roll bar damper according to claim 1, characterized in that the damping spring and the spring fastening rod are a parallel composite structure, matched with a damping adjustment rod, with one end connected to the automotive anti-roll bar, and the other end connected to the anti-roll bar link or suspended lower straight arm or lower control arm.

9. The novel automotive anti-roll bar damper according to claim 1, characterized in that, in the anti-roll bar damper, when the length of the inner rod of the spring fastening rod in the parallel composite structure of the spring and the spring fastening rod is relatively small, the inner rod of the spring fastening rod is pulled out, the inner rod of the spring fastening rod is unidirectionally clamped and limited by the outer rod sealing ring, and the entire damper becomes a hard connection.

10. The novel automotive anti-roll bar damper according to claim 1, characterized in that the angle formed between the anti-roll bar damper and the anti-roll bar when the anti-roll bar damper is connected to the anti-roll bar and the anti-roll bar link is adjusted between 0 degrees and 90 degrees, and the angle formed between the anti-roll bar damper and the anti-roll bar when the anti-roll bar damper is connected to the anti-roll bar and the lower straight arm is adjusted between 0 degrees and 90 degrees.

11. The novel automotive anti roll bar damper according to claim 1, characterized in that the damping spring and the spring fastening rod have another assembly structure, with the spring fastening rod on the outside and the damping spring inside the spring fixing cylinder.

12. The novel automotive anti roll bar damper according to claim 2, characterized in that the spring fastening rod is a low damping rod, divided into an outer cylinder and an inner rod; the initial length of the spring fastening rod is between 2 millimeters and 600 millimeters, and the fully stretched length of the spring fastening rod is between 5 millimeters and 1200 millimeters; the outer cylinder is fixed and the inner rod is sealed with a sealing ring inside the outer cylinder; and the spring fastening rod fixes and limits the spring.

13. The novel automotive anti roll bar damper according to claim 2, characterized in that the damping spring includes three settings: a double-end necked spring, a center-necked spring, and a single-sided necked spring; the damping spring has a wire diameter between 0.1 mm and 20 mm, an inner diameter between 2 mm and 100 mm, and a length between 2 mm and 500 mm; the damping spring is sleeved outside the spring fastening rod and has a composite telescopic structure with the spring fastening rod; the damping is increased when the damping spring is stretched, and the damping spring returns to its initial position together with the inner rod of the spring fastening rod when retracted.

14. The novel automotive anti roll bar damper according to claim 2, characterized in that the left and right end fastening hoops are annular or U-shaped fastening hoops, the annular fastening hoop has a radius ranging from 2 millimeters to 80 millimeters, and the U-shaped fastening hoop has a length ranging from 2 millimeters to 150 millimeters and a width ranging from 5 millimeters to 200 millimeters; one end of the anti-roll bar damper is fixed to the anti-roll bar of the vehicle, and the other end of the anti-roll bar damper is fixed to the anti-roll bar link, or to the suspension straight arm or fixed point near the anti-roll bar; and the inner diameter of the fastening hoops is circular or rectangular.

15. The novel automotive anti-roll bar damper according to claim 2, characterized in that one end of the damping spring is connected to the automotive anti-roll bar, and the other end of the damping spring is connected to the anti-roll bar link or suspension lower straight arm or lower control arm or fixed point.

16. The novel automotive anti-roll bar damper according to claim 2, characterized in that, in the anti-roll bar damper, when the length of the inner rod of the spring fastening rod in the parallel composite structure of the spring and the spring fastening rod is relatively small, the inner rod of the spring fastening rod is pulled out, the inner rod is unidirectionally clamped and limited by the outer rod sealing ring, and the entire damper becomes a hard connection.

17. The novel automotive anti-roll bar damper according to claim 2, characterized in that the damping spring and the spring fastening rod have another assembly structure, with the spring fastening rod on the outside and the damping spring inside the spring fixing cylinder; one end of the damping spring is fixed to an closed end inside the outer cylinder of the spring fastening rod, and the other end of the damping spring is fixed to the inner rod of the spring fastening rod and is inserted into the outer cylinder end, sealed and fixed with a sealing ring.
